(19) United States
(12) Patent Application Publication
(10) Pub. No.: US 2016/0171177 A1
(43) Pub. Date: Jun. 16, 2016

(54) SYSTEM TO CREATE AND ADJUST A HOLISTIC CARE PLAN TO INTEGRATE MEDICAL AND SOCIAL SERVICES

(71) Applicant: KONINKLIJKE PHILIPS N.V., Eindhoven (NL)

(72) Inventors: Jennifer CAFFAREL, Eindhoven (NL); Gijs GELEIJNSE, Geldrop (NL); Privender Kaur SAINI, Veldhoven (NL)

(21) Appl. No.: 14/962,529

(22) Filed: Dec. 8, 2015

Related U.S. Application Data
(60) Provisional application No. 62/089,872, filed on Dec. 10, 2014.

(51) Int. Cl. G06F 19/00

(52) U.S. Cl. CPC G06F 19/3481; G06F 19/328

(57) ABSTRACT

To create a patient care plan for a target patient, inputs (66, 68, 70, 72) related to one or more social services (54) and one or more medical services (52) that are each associated with target data are received. One or more social and medical services (52, 54) are selected based on a target patient assessment. A net care benefit is calculated for each of the selected services (52, 54). An outcome patient care plan (106) is created from outcomes (92) including the selected services (52, 54) with a highest net care benefit.

### CROSS-REFERENCE TO PRIOR APPLICATIONS

This application claims priority of U.S. Provisional Application Ser. No. 62/089,872, filed Dec. 10, 2014. This application is incorporated by reference herein

### FIELD

The present application relates generally to systems and methods for creating and adjusting a holistic care plan for a patient. It finds particular application in conjunction with systems and methods for integrating medical and social services into a care plan for a patient and will be described with particular reference thereto. However, it is to be understood that it also finds application in other usage scenarios and is not necessarily limited to the aforementioned application.

### BACKGROUND

Many chronic disease management programs focus on monitoring and treating a patient's condition, while educating and empowering patients (and informal care givers) to take better care of themselves. It is natural to concentrate efforts on the medical needs of the patient. However, a crucial aspect of a patient's care also involves addressing the patient's psychological and social needs.

In clinical practice, medical needs are mainly addressed by the clinical care team. The psychological and social needs of the patient, if addressed, may be reviewed by a healthcare professional (e.g., a discharge nurse, a social worker linked to the hospital, and the like) prior to patient discharge from a hospital. When the disease burden increases for the patient, the need for services addressing the psycho-social status of the patient can increase accordingly. Furthermore, there is a general acceptance that addressing the psycho-social needs of a patient positively influences the patient's medical outcomes. Unfortunately, the patient's careplan is rarely approached in an integrated and standardized fashion to account for both medical and psycho-social aspects.

While most healthcare professionals will focus on treating a patient's disease, the patient's ideal treatment plan should help to find the right “disease-life” balance. For example, the patient should learn how to manage their disease such that they can carry out their lives as normally as possible. However, in practice, medical and social services assessment and delivery are often separated, and are rarely integrated to form a holistic careplan for the patient. The delivery of medical services is often well structured and understood (e.g., services provided in several outpatient clinics of one hospital system). For example, medical services are generally well established and are delivered within a fairly structured system (e.g., guidelines and policies that exist to establish eligibility and reimbursement criteria).

Social services, on the other hand, can be provided by official organizations and/or community/voluntary organizations. The referral, financing, and delivery of social services is much more fragmented and complex. For example, social services can be provided by different service providers that are both formal and informal. In another example, entitlement and financing aspects in a hospital system can be unclear. While medical services target well-defined quantifiable outcomes (e.g., readmissions, mortality, and the like), the benefits of social services are generally expressed in more qualitative terms of well-being, patient satisfaction, and quality of life. In addition, the financial budget for the patient is often limited. As a result, the social services may no longer be affordable since the budget is primarily allocated to the medical services. A hospitalization or visit to the primary care physician is a good opportunity to evaluate the need for services on a holistic level. Such a discussion may lead to difficult decisions to trade off curative medical services (such as daily home nurse visits) with social services (such as visits from a social worker, a food bank, and the like).

There is a general consensus that both medical and social needs of a patient should be identified and addressed. However, there is still a lack of coordination and integration in practice. There are several reasons for this, including conservatism, assessment, and difficulty in assessing social service outcomes and a lack of knowledge how to integrate medical and social needs.

First, medical sciences and social sciences are often viewed as well-distinguished and separate. This can lead to a discipline communication gap.

Second, medical health assessments to evaluate a patient's needs are judged to be more concrete, quantitative and well established, as illustrated by the drive towards evidence-based medicine. There is a lack of consensus on how to assess the social needs of a patient. Social needs are often seen as more qualitative and abstract than medical health needs.

Third, the evidence-based medicine mantra strongly advocates structured evaluation of medical services. However the breadth of aspects of a patient's psyche or life that social services affect makes it difficult to assess and pinpoint specific and generalizable outcomes.

### SUMMARY

The present disclosure provides new and improved systems and methods which overcome the above-referenced problems and others.

This present disclosure aims to support the creation of a tailored integrated care plan to address both medical and psycho-social needs of a patient in two ways. First, the present disclosure provides systems and methods for defining how to identify which profiles of patients need which service (e.g., based on population level). This criterion is based on patients' general medical and psycho-social profile and also takes into account organizational and financial constraints. Second, the present disclosure provides systems and methods for matching specific services or tailoring the elements of the service according to a patient's current status and assessment of acuity level/risk in order to maximize outcomes (e.g., based on the individual patient level). The general patient profile and individual status are derived from a holistic patient assessment which combines medical and psycho-social needs of the patient.

In accordance with one aspect, a method for creating a patient care plan for a target patient is provided. Inputs related to one or more social services and one or more medical services that are each associated with target patient data are received. One or more social and medical services are selected based on a target assessment. A net care benefit is calculated for each of the selected services. An outcome patient care plan is created from outcomes including the selected services with a highest net care benefit.

One advantage resides in offering social services to a patient.

Another advantage resides in finding locally available social, including psycho-social services to a patient.

Another advantage resides in finding a balance between medical treatments and social service treatments.

Another advantage resides in reducing costs while optimizing treatment for a patient.

Still further advantages of the present disclosure will be appreciated to those of ordinary skill in the art upon reading and understanding the following detailed description.

### BRIEF DESCRIPTION OF DRAWINGS

The disclosure may take form in various components and arrangements of components, and in various steps and arrangements of steps. The drawings are only for purposed of illustrating the preferred embodiments and are not to be construed as limiting the disclosure.

FIG. 1 is a schematic view showing a patient care plan system in accordance with one aspect of the present disclosure;

FIG. 2 is a chart showing various services and outcomes associated with the patient care plan system of FIG. 1;

FIG. 3 is a schematic view showing multiple components of the patient care plan system of FIG. 1;

FIG. 4 is an exemplary flow chart of one example use of the patient care plan system of FIG. 1; and

FIG. 5 is a schematic view showing another example use of the patient care plan system of FIG. 1.

### DETAILED DESCRIPTION

The present disclosure is directed to systems and methods for creating and adjusting a holistic care plan for a patient. As discussed in more detail below, the systems and methods of the present disclosure provide integration of medical services and social services into a care plan for a patient. The present disclosure creates a tailored integrated care plan to address both medical and psycho-social needs of a patient. Advantageously, the systems and methods of the present disclosure provide a processor that: (1) defines how to identify which services a patient needs based on patients' general medical, organizational, and psycho-social profile and account for medical, organizational, and financial constraints; (2) matches specific services or tailoring the elements of the service according to a patient's current status and assessment of acuity level/risk in order to maximize outcomes; and (3) integrates medical and social services into a holistic care plan for a patient.

As used herein, the term “service” and variants thereof refers to interventions and treatments that exist to treat conditions and/or issues and to maintain the quality of life of the individual patient. Services can be provided by healthcare professionals (formal healthcare services), social workers, private service providers, charities, or members of the community.

As used herein, the term “outcome” and variants thereof refers to a quantifiable result of a clinical and/or a psycho-social service. Outcomes are defined per service or per group of services.

As used herein, the term “classifier” and variants thereof refers to a class or label applied to a concept, such as each type of service. For example, a patient record that is enriched with additional data based on the patient is classified per service type. In another example, a service can be associated with multiple classes or labels.

As used herein, the term “status” and variants thereof refers to a quantifiable evaluation of a patient's medical and well-being.

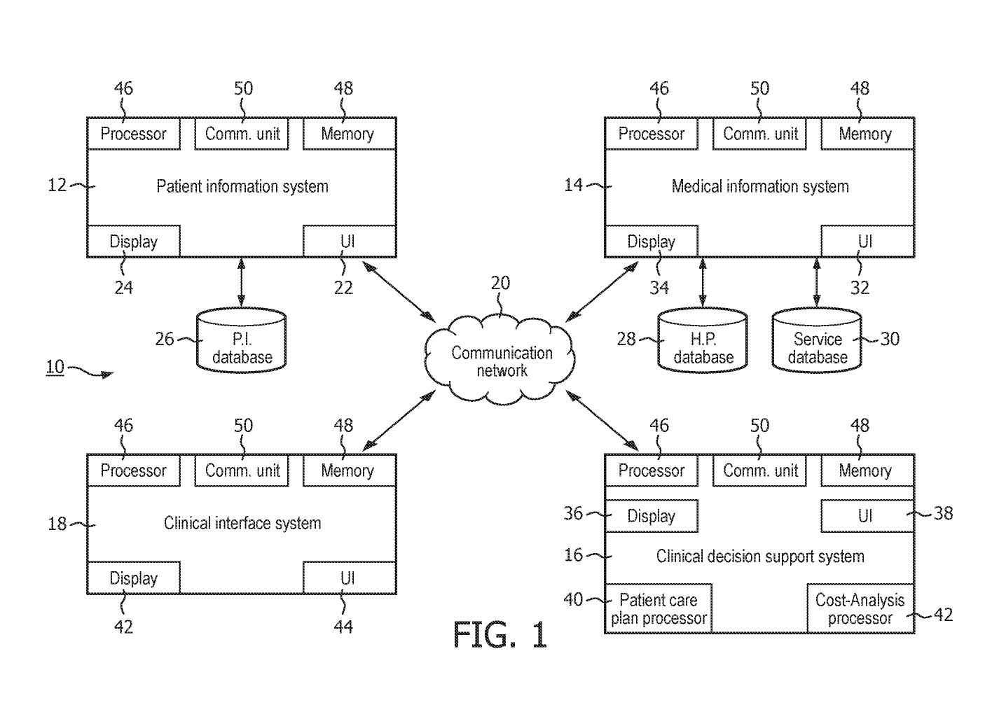

With reference to FIG. 1, a block diagram illustrates one embodiment of an patient care plan system 10 of a medical institution, such as a hospital. The patient care plan system 10 suitably includes a patient information system 12, a medical information system 14, a decision support system (DSS) 16, and a clinical interface system 18 and the like, interconnected via a communications network 20. It is contemplated that the communications network 20 includes one or more of the Internet, Intranet, a local area network, a wide area network, a wireless network, a wired network, a cellular network, a data bus, and the like. It should also be appreciated that the components of the patient care plan system 10 be located at a central location or at multiple remote locations.

The patient information system 12 stores patient data related to one or more patients being treated by the medical institution. The patient data include physiological data collected from one or more sensors, laboratory data, imaging data acquired by one or more imaging devices, clinical decision outputs (e.g., early warning scores, state of the patient, etc.), and the like. The patient data may also include the patient's medical records, the patient's administrative data (e.g., patient's name, location, and the like), the patient's clinical problem(s), the patient's demographics such as weight, age, family history, co-morbidities, and the like. In a preferred embodiment, the patient data includes a unique identifier, medical indication, age, gender, body mass index, systolic/diastolic blood pressure, relevant blood markers, the results of medical questionnaires about the patient's medical and quality of life, and the like. Further, the patient data can be gathered automatically and/or manually. As to the latter, a user input device 22 can be employed. In some embodiments, the patient information system 12 includes one or more display devices 24 that provides users a user interface within which to manually enter the patient data and/or for displaying generated patient data. In one embodiment, the patient data is stored in the patient information database 26. Examples of patient information systems include, but are not limited to, electronic medical record systems, departmental systems, and the like.

Similarly, the medical information system 14 store medical data collected from a population that is related to the patient being treated. For example, the medical information system 14 stores population level medical data relating to various clinical problems of differing populations of patients. The medical data include population level knowledge from literature, retrospective studies, clinical trials, clinical evidence on outcomes and prognosis, and the like. In one embodiment, the medical data includes historical patient data including the medical indication of patients, the interventions that were prescribed to them, their medical outcomes and healthcare resource consumption which is stored in a historical patient database 28. The Health Management System (i.e. operational data specific to an institution, can include medical, psycho-social data, as well as process data) and can include the Patient Information System and data from individuals and from populations. A Medical Knowledge System (i.e., some form of knowledge repository system) can include data from literature and research databased. The information on past interventions and historical patient database can be based in one or the other with a link (automatic or manual) between the Health Management Systems and the Knowledge Database so that these Intervention and Historical Patient databases would be based on data from the Institution (and/or a combination of data from other sites or sources). In another embodiment, the medical data also includes service data relating to collected medical outcomes and costs for patients who underwent the services of interest which are stored in an service database 30. Further, the medical data can be gathered automatically and/or manually. To enter the data manually, one or more user input devices 32 can be employed. In some embodiments, the medical information systems 14 include display devices 34 providing users a user interface within which to manually enter the medical data and/or for displaying generated medical data. Examples of medical information systems include, but are not limited to, medical literature databases, medical trial and research databases, regional and national medical systems, and the like.

The DSS 16 stores clinical models and algorithms embodying the clinical support tools or patient decisions aids. The clinical models and algorithms typically include one or more suggested or entered diagnosis and/or treatment options/orders as a function of the patient data and the clinical problem of the patient being treated. Further, the clinical models and algorithms typically generate medical, lifestyle, and/or psycho-social data that include one or more interventions for the various diagnosis and/or treatment options and the clinical context based on the state of the patient and the patient data. Specifically, the clinical models and/or guidelines are determined from the diagnoses and/or treatment orders for patients with specific diseases or conditions and are based on the best available evidence, (i.e., based on clinical evidence acquired through scientific method and studies, such as randomized clinical trials). After receiving patient data, the DSS 16 applies the clinical model and algorithm pertinent to the clinical problem of the patient being treated and generates medical data including one or more services for the various diagnosis and/or treatment options. It should also be contemplated that as more patient data becomes available, the DSS 16 updates the medical data including one or more services for the diagnosis and/or treatment options available to the patient. The DSS 16 includes a display 36 (such as a CRT display, a liquid crystal display, a light emitting diode display, and the like) to display the clinical models and algorithms and a user input device 38 such as a keyboard and a mouse, for the clinician to input and/or modify the clinical models and algorithms. The DSS 16 further includes a patient care plan processor 40 and a cost analysis processor 42, as described in more detail below.

The clinical interface system 18 enables the user to input the patient values, lifestyle regimes, ability-to-pay, and preferences related to diagnosis and treatment from a patient's perspective which are used to select the most cost-effective service for a specific patient from multiple service programs applicable to that patient's clinical condition. In one embodiment, the clinical interface system 18 enables the user to enter specific settings for the cost-effectiveness analysis. These settings may include time horizon for the analysis, discount rates for effects and costs, and ability-to-pay. The clinical interface system 18 also receives a quantitative evaluation and comparison of the alternative choices of services to the patient (not shown) being treated in the medical institution. For example, the clinical interface system 18 displays the quantitative evaluation and comparison of the choices of services including a comparison of alternative choices on the same measure, such as allowing the patients to adjust for lifestyle regime and preferences, outcome parameters, patient pathways, a desired probability of an overall outcome or of a specific outcome parameter, and the like including the cost effects of those choices. The clinical interface system 18 includes a display 42 (such as a CRT display, a liquid crystal display, a light emitting diode display, and the like) to display the evaluation and/or comparison of choices and a user input device 44 such as a keyboard and a mouse, for the user to input the patient values and preferences and/or modify the evaluation and/or comparison. Examples of clinical interface systems 18 include, but are not limited to, a software application that could be accessed and/or displayed on a personal computer, web-based applications, tablets, mobile devices, cellular phones, and the like.

The components of the patient care plan system 10 suitably include processors 46 executing computer executable instructions embodying the foregoing functionality, where the computer executable instructions are stored on memories 48 associated with the processors 46. It is, however, contemplated that at least some of the foregoing functionality can be implemented in hardware without the use of processors. For example, analog circuitry can be employed. Further, the components of the patient care plan system 10 include communication units 50 providing the processors 46 an interface from which to communicate over the communications network 20. Even more, although the foregoing components of the patient care plan system 10 were discretely described, it is to be appreciated that the components can be combined.

The DSS 16 also selects the most cost-effective intervention or treatment for a specific patient from multiple interventions or treatment programs applicable to that patient's clinical condition.

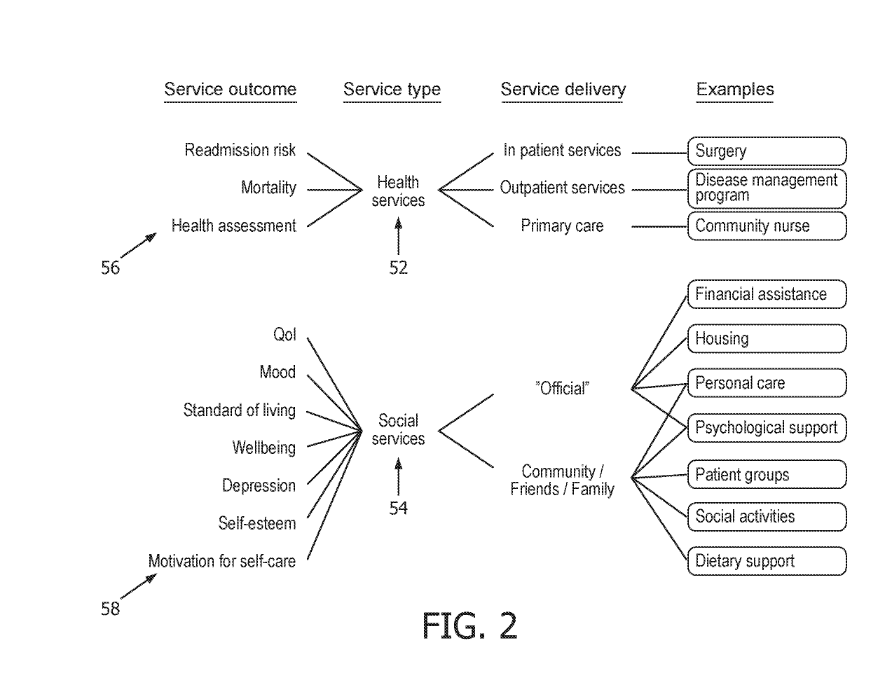

In one example, a plurality of input medical services 52 and a plurality of input social services 54 are stored in the service database 30. With reference to FIG. 2, the plurality of medical services 52 are each associated with a plurality of medical service outcomes 56, and the plurality of social services 54 are each associated with a plurality of social service outcomes 58. In one example, the medical services 52 are selected from a group that includes inpatient services (e.g., surgery and the like), specialized outpatient services (e.g., disease management programs and the like), primary care (e.g., a community nurse and the like), rehabilitation services (e.g., physical therapy and the like), mental medical services (e.g., psychiatry and the like), and palliative care (e.g., preventative care and the like). The medical service outcomes 56 include readmission risk, mortality, and medical assessment of the patient, among others.

In another example, the social services 54 can include both social care services and community resources. The social services 54 are selected from a group that includes financial assistance services, housing services, personal care services, psychological support services, patient group services, social activities services, dietary support services, employment services, income services, legal services, transportation and mobility services, care management services, home care services, information and assistance services, long-term care services, nutrition and meals services, respite services, senior services, volunteer and intergenerational services, and wellness and well-being services. The social service outcomes 58 include quality of life, patient mood, standard of living, wellbeing, depression, self-esteem, motivation for self-care, and patient engagement, among others. For example, if the medical service 52 is telemedicine monitoring, the medical service outcome 56 includes days without hospitalization, drug therapy adherence (e.g., measured by number of intake moments missed); blood pressure levels; status of self-reported symptoms (e.g., pain level) and the like. In another example, if the social service 54 is a food delivery program, the social service outcome 58 includes body weight, reported satisfaction, and the like.

The selected services 52 and 54 are cross-checked to ensure that they optimally address the mix of psycho-social determinants and clinical needs. For example, the selected services 52 and 54 are associated with a confidence score that indicates the applicability of the services to a target case. These confidence scores are based on evidence of services 52 or 54 prescribed or arranged for similar past target cases. By doing so, potentially overlapping and/or conflicting services are highlighted such that there is no redundancy in the patient's careplan. As a result, the effectiveness and cost of the selected services 52 and 54 are balanced to see if similar needs are being addressed. For example, it is important to flag a medical service 52 which would provide a good medical outcome, but a lower quality of life due to intense daily clinic visits, especially if one of the aims of the careplan is to address the quality of life via a selected social service 54. A user can tailor the social service 54 to compensate for the additional loss in the social outcome 58 (e.g., quality of life) or tailor the selected medical service 52 by seeking other ways to deliver it (e.g., ambulatory or home care).

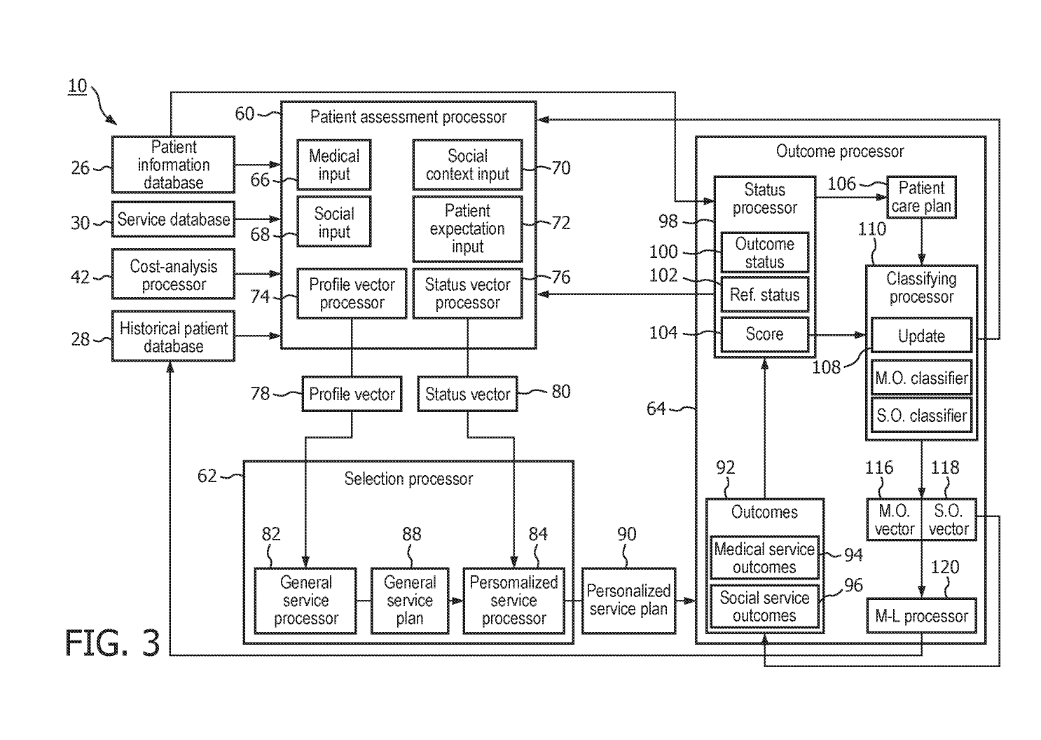

With reference to FIG. 3, the DSS 16 also selects the most cost-effective intervention or treatment for a specific patient from multiple service programs applicable to that patient's clinical condition. Specifically, the DSS 16 includes the patient care plan processor 40 which generates a patient care plan utilizing the medical data stored in medical information system 14. The patient care plan processor 40 generates patient care plan model in the form of a support vector machine, Bayesian classifier, or any other statistical model that can be used to associates cases with outcomes and recommendations for interventions or services. Other applicable prediction models will be known to those skilled in the art. The generation of the patient care plan is described in more detail below.

The cost analysis processor 42 retrieves detailed patient data from a specific patient from the patient information system 12 and utilizes the patient care plan, the one or more service for the various diagnosis and/or treatment options, and medical data from the medical information system 14 and information on insurance or financial constraints to calculate predictions for the medical and cost outcomes of the patient. For example, the cost analysis processor 42 receives predictions of medical outcomes and healthcare resource consumption to estimate costs and effects of the services of interest specific to the specific patient. The cost analysis processor 42 generates displays for the estimated costs and effects specific to the patient for each intervention. Based on the result of comparing costs and effects, a recommendation for the most cost-effective intervention for the patient is displayed on the clinical interface system 18.

Specifically, the cost analysis processor 42 retrieves relevant patient data from the patient information system 12 that are utilized in the prediction model including name, medical indication, age, gender, body mass index, systolic/diastolic blood pressure and values of blood markers specific to the medical indication. The cost analysis processor 42 utilizes the patient care plan to generate medical outcomes, such as estimated survival rates (projected or estimated) and hospital admission rates. These rates are then further used by the cost analysis processor 42 to compute effects and costs over a given time horizon for each intervention. Costs are subtracted from the gross medical effects after adjusting the costs by a so-called “ability-to-pay” value (e.g., the amount of money the patient is able and/or willing to pay for the services). For each service, this results in a value with a unit equal to the medical effects, called the “net medical benefits”. The service with the highest net medical benefits is then recommended to the user.

In another example, the cost analysis processor 42 predicts the patient-specific medical, social, and economic outcomes (e.g., disease-related risks or hazards for a target patient) based on results from retrospective data analysis of patient, outcome and cost data. The outcomes are then combined in a cost analysis to establish the most cost-effective service for the patient. Different intervention or treatments are compared using a quantity known as the “net medical benefits”, which includes medical outcomes (weighted by quality of life), expected costs, as well as the ability-to-pay (amount able to invest for the service). A recommendation of this service is provided to the user via the clinical interface system 18.

In another example, the cost analysis processor 42 couples the direct costs with estimated patient risks by using time integrals, correct for quality of life, and performs a cost analysis for each service strategy. These estimations allow for comparison between service strategies on risk (estimated outcome), direct costs (accumulated over time, given the risks) and cost-effects, to be varied over different time horizons (30-days, one-year, life-time, and the like). A ranked list or a single recommendation of most cost-effective service strategies can then be provided to the decision maker (e.g., clinical specialist) or the patient via the clinical interface system 18.

In another embodiment, the cost analysis processor 42 provides the net medical benefits change as a function of the ability-to-pay. The net medical benefits of selected services can be visualized to the user as a function of the ability-to-pay. This analysis is used to indicate if a single service is always dominating other services (i.e., the net medical benefits are always higher for this service, regardless of the ability-to-pay). It may also be indicated if a combination of multiple services is dominating other services over the entire range of ability-to-pay values (e.g., service 1 results in the highest net medical benefits for ability-to-pay values below “X”, and service 2 results in the highest net medical benefits for ability-to-pay values above “X.”)

In a further embodiment, the cost analysis processor 42 provides a cost analysis for two or more services for a patient population. For example, the net medical benefits may be aggregated over multiple patients who, given their medical condition, are eligible for the same services. This information may be used to recommend a service for a population of patients. The patient population is derived on both medical and social aspects.

The patient care plan processor 40 is associated with each of the patient information database 26, the historical patient database 28, and the cost analysis processor 42. The patient care plan processor 40 includes an assessment processor 60, a selection processor 62, and an outcome processor 64. The patient care plan processor 40 includes an assessment processor 60 that assesses a target patient's profile to select focus needs and related outcomes for the target patient. This assessment is expressed through clinical and psycho-social aspects. For example, the assessment processor 60 receives and assesses medical inputs 66 (e.g., heart conditions, respiratory conditions, illnesses, and the like), social inputs 68 (dementia, anger issues, lack of coping skills, and the like), social context inputs 70 (e.g., marital status, children, pets, relatives, friends, etc.), and patient expectation inputs 72 (living at home, assisted living, regain dexterity, regain movement, etc.).

A profile vector processor 74 and a status vector processor 76 of the assessment processor 60 uses the inputs 66, 68, 70, and 72 to generate vectors relating to the inputs. In one example, the profile vector processor 74 generates a profile 78, such as a profile vector, of the patient using the inputs 66, 68, 70, and 72. The profile vector processor 74 includes an input-to-vector mapping process to generate the profile vector 78. Specifically, the profile vector processor 74 extracts context information values of each input 66, 68, 70, and 72 and converts these values to vector values of the profile vector 78. For example, each input 66, 68, 70, and 72 is input into a pre-calculated lookup table, a neural network, or the like. Subsequently, the profile vector 78 is used to determine the optimal service arrangement to serve the selected psycho-social determinants and/or the selected clinical outcomes, as described in more detail below.

In another example, the status vector processor 76 generates a status 80, such as a status vector, of the target patient using the inputs 66, 68, 70, and 72. The status vector processor 76 includes an input-to-vector mapping process to generate the status vector 80. Specifically, the status vector processor 76 extracts context information values of each input 66, 68, 70, and 72 and converts these values to vector values of the status vector 80. For example, each input 66, 68, 70, and 72 is input into a pre-calculated lookup table, a neural network, or the like. Subsequently, the status vector 80 is used to determine the optimal service arrangement to serve the selected psycho-social determinants and/or the selected clinical outcomes, as described in more detail below.

The selection processor 62 selects which of the medical services 52 and the social services 54 would benefit the target patient based on the profile vector 74 and the status vector 80. In other words, the selection processor 62 selects the medical services 52 and the social services 54 that have the best effect on both the medical and well-being of the target patient. For example, the selection processor 62 provides: (1) a general view of the patient's needs and uses clustering methods to allocate services 52 and 54 on a generic population level; and (2) a specific view of the patient's needs to allocate services 52 and 54 solely for the target patient. To do so, the selection processor 62 includes a general service processor 82 and a personalized service processor 84.

The general service processor 82 is programmed to select generic medical services 52 and generic social services 54 based on the profile vector 74. For example, the assessment processor 60 transfers the profile vector 74 after generation thereof to the general service processor 82. The general service processor 82 also receives information from the patient input database 26 (e.g., patient data), the historical patient database 28 (e.g., medical data collected from a population that is related to the patient), and the cost-analysis processor 42 (e.g., ability of the patient to pay for the medical services 52 and/or the social services 54). The general service processor 82 includes a data-mining processor 86 that is programmed to search the service database 30 for medical services 52 and/or social services 54 that correspond to the profile vector 78, the patient data from the patient input database 26, the population data from the historical patient database 28, and the net health benefit analysis from the cost-analysis processor 42. From this information, the general service processor 82 creates a general service care plan 88 that includes the selected medical services 52 and the selected social services 54 that correspond to the needs of the population with similar profile vectors 78 to that of the target patient.

The personalized service processor 84 is programmed to select personalized medical services 52 and personalized social services 54 based on the status vector 80. For example, the assessment processor 60 transfers a personalized status vector 80 after generation thereof to the personalized service processor 84. The personalized service processor 84 also receives the general service care plan 88 from the general service processor 82. The personalized service processor 84 includes a data-mining processor 90 that is programmed to search the general service care plan 88 for medical services 52 and/or social services 54 that correspond to the status vector 80. The personalized service processor 84 creates a personalized service plan 90 that includes the selected medical services 52 and the selected social services 54 that correspond to the personalized needs of the target patient based on the status vector 80 thereof.

In another example, the outcome processor 64 is programmed to continuously monitor and evaluate the outcomes 92 of the personalized service plan 90. To do so, the outcome processor 64 receives the personalized service plan 90 from the personalized service processor 82 and simulates the personalized service plan 90 to predict the outcomes 92. The outcomes 92 include medical service outcomes 94 and social service outcomes 96.

The outcome processor 64 includes a status processor 98 that identifies and classifies the medical services outcomes 94 and the social service outcomes 96. Each outcome 92 is quantified on a scale of 0 (very unfavorable) to 100 (most favorable). For each outcome 92, the status processor 98 computes an outcome status 100 for each possible outcome 92 that is based on the personalized service plan 90 in combination with measurements from patient monitors, usage of devices, recent clinical data, and other known information to assess the target patient on the various outcomes statuses 100. The outcome statuses 100 defines the actual current assessment of the target patient, and are transferred to the patient assessment processor 60, as described in more detail below.

In another example, the status processor 98 is programmed to compute a reference status 102 for each outcome 92 for a population of patients similar to the target patient. To do so, the status processor 98 computes multiple outcome statuses 100 for multiple patients that correspond to the needs of the population with similar profile vectors 78 to that of the target patient. The reference statuses 102, once computed, are transferred to the historical patient database 28, as described in more detail below.

In a further example, the status processor 98 is programmed to compute a score 104 for each outcome 92. To do so, the outcome status processor 98 subtracts the reference statuses 102 from the outcome statuses 100 for each outcome 92. In one example, a positive score 104 indicates that the expected outcome 92 is better than for a population of patients similar to the patient (e.g., the target patient does not need a service 52 or 54 for the outcome 92). In another example, a negative score 104 indicates that the expected outcome 92 is worse than for the population of patients similar to the patient (e.g., the target patient needs a service 52 or 54 for the outcome 92). The scores 104, once computed, are transferred back to the general service processor 82, as described in more detail below. Once the scores 104 have been calculated, the selected medical service outcomes 94 and social service outcomes 96 are used to create a patient care plan 106. The services 52 and 54 are then installed in the target patient's house.

The status processor 98 is programmed to produce self-effectiveness evaluation updates 108 of the patient care plan 106. To do so, the scores 104 are collected into a classifying processor 110 of the status processor 98 for sorting the outcomes 92. The classifying processor 110 can include a medical outcome classifier 112 and a social outcome classifier 114. In one example, the medical outcome classifier 112 and the social outcome classifier 114 generate medical outcome vectors 116 and social outcome vectors 118, respectively, that each include a label. The medical outcome classifier 112 and the social outcome classifier 114 each include an input-to-vector mapping process to generate the medical outcome vectors 116 and the social outcome vectors 118. Specifically, the medical outcome classifier 112 and a social outcome classifier 114 extract context information values of each score 104 converts these values to vector values of the medical outcome vector 116 and the social outcome vector 118. For example, each score 104 is input into a pre-calculated lookup table, input into a neural network, or the like.

The medical outcome vector 116 and the social outcome vector 118 are compared to similar vectors contained within the historical patient database 28 using a machine-learning processor 120 (e.g., K-nearest neighbors, support vector machines, decision tree learning, support vector machines, neural networks, inductive logic programming, clustering, association rule learning, Bayesian networks, reinforcement learning, representation learning, similarity learning, sparse dictionary learning, and the like). For example, a social service 54 of “meal services” is included in a previously-obtained social outcome vector 118 that is compared to the social outcome vector 118 for the target patient. The medical outcome vector 116 and the social outcome vector 118 are then calculated for each medical service 52 and each social service 54. Consequently, the patient care plan 106 can be updated and improved based on patient care plans for other patients similar to the target patient. The evaluation updates 108, once computed, are recirculated into the status processor 98 to further refine the patient care plan 106.

In addition, the outcomes statuses 100, the references statuses 102, and the scores 104 are similarly inputted back into the patient assessment processor 60, the historical patient database 28, and the general service processor 82, respectively, to continuously update the patient care plan 106. For example, the selected outcomes 92 of the patient care plan 106 are revisited for the mortality score 104. The mortality score 104 is used to balance the focus between medical services 52 and the social services 54. In other words, the higher the chance of early mortality, the more budget is allocated for the social services 54 via the cost analysis processor 42. The cost analysis processor 42 re-computes the balance between the medical services 52 and social services 54. The services 52 and 54 are selected that optimize the selected outcomes 92 within the service and clinical budget.

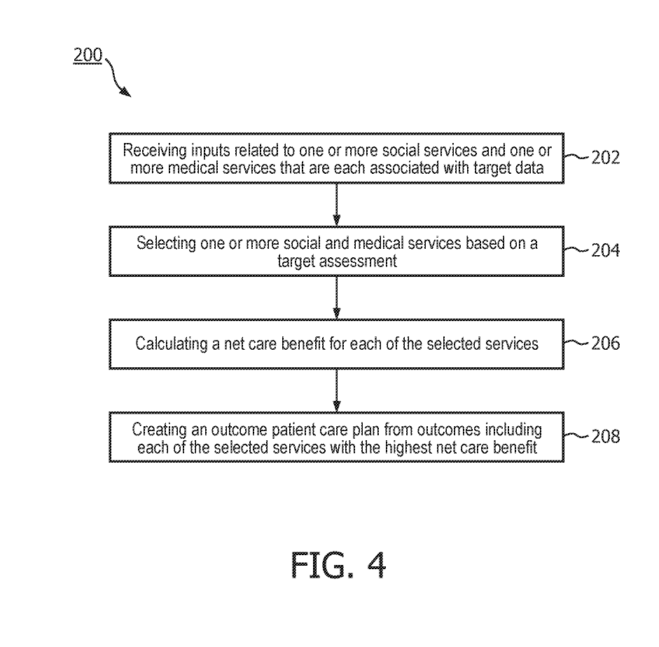

With reference to FIG. 4, a method 200 for creating a patient care plan is provided. At Step 202, inputs 66, 68, 70, 72 related to one or more social services 54 and one or more medical services 52 that are each associated with target data are received. At Step 204, one or more social and medical services 52, 54 are selected based on a target assessment. At Step 206, a net care benefit is calculated for each of the selected services 52, 54. At Step 208, the patient care plan 106 is created from outcomes 92) including each of the selected services 52, 54 with the highest net care benefit.

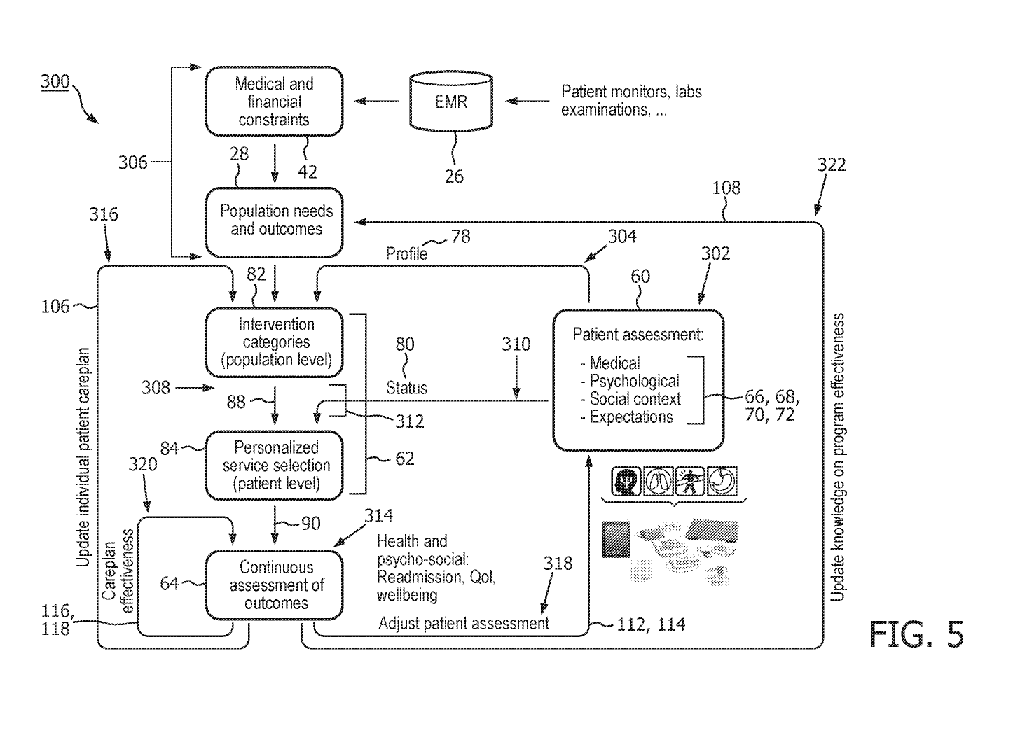

With reference to FIG. 5, a method 300 is provided for creating the patient care plan 106 is provided. At Step 302, inputs 66, 68, 70, 72 related to one or more social services 54 and one or more medical services 52 that are each associated with target data are received in the assessment processor 60. At Step 304, the profile vector 78 is generated. At Step 306, data from the patient database 26, the historical patient database 28, the cost analysis processor 42, and the profile vector 78 are received by the general service processor 82. At Step 308, the generalized service plan 88 is generated. At Step 310, the status vector 80 is generated. At Step 312, the generalized service plan 88 and the status vector 80 are received by the personalized service processor 84. At Step 314, the personalized service plan 90 is generated and transferred to the outcome processor 64. At Step 316, the patient care plan 106 is generated from the scores 104 of the personalized service plan 90. At Step 318, the medical and social service outcome classifiers 112 and 114 are generated and transferred to the assessment processor 60. At Step 320, the medical and social outcome vectors 116 and 118 are generated and transferred to the outcome status processor 98. At Step 322, the evaluation updates 108 are generated and transferred to the historical patient database 28.

### EXAMPLE

In one example of the method 200 or 300, a 75 year old male patient (“the patient”) is suffering from heart failure, chronic obstructive pulmonary disease (“COPD”), and has difficulties managing his temper and has short-term memory problems. He is a widower and lives only with a dog. He is hospitalized for pneumonia. He wishes to return home and live relatively independently for the next 10 years.

The patient's medical conditions are inputted into the patient input database 26, and his cost conditions are input into the cost analysis processor 42 by a multi-disciplinary team of medical and social care professionals. The assessment processor 60 receives and assesses the data from the patient input database 26. For example, the assessment processor 60 sorts the data from the patient input database 26 into medical inputs 66 (e.g., heart failure, COPD, pneumonia), social inputs 68 (e.g., onset dementia, lack of anger coping skills), social context inputs 70 (e.g., widowed, lives with a dog), and patient expectation inputs 72 (e.g., return home, live independently for the next 10 years). From the inputs 66, 68, 70, and 72, the profile vector processor 74 generates the profile vector 78 and the status processor 76 generates the status vector 80.

The selection processor 64 then selects which of the medical services 52 and the social services 54 from the service database 30 that would benefit the patient based on the profile vector 74 and the status vector 80. The general service processor 82 creates the general service care plan 88 that includes the selected medical services 52 and the selected social services 54 that correspond to the needs of the population with similar profile vectors 78 to that of the patient. For example, the selected general medical services 52 include pulmonary rehabilitation service upon discharge and physical activity. The selected general social services 54 include temporary home care (e.g., a home medical care worker to provide services hygiene, food, logistics, and the like), nutritional services, psychological care, neurological consultations, and the like.

The personalized service processor 84 creates the personalized service plan 90 that includes the selected medical services 52 and the selected social services 54 that correspond to the personalized needs of the patient based on the status vector 80 thereof. For example, the personalized medical services 52 include: (1) a pulmonary rehabilitation service that can be held at a local outpatient clinic; be an individualized session; and can be scheduled on desired days of the week; and (2) a physical activity plan that includes regular dog walks; and walks that can be adjusted to account for the patient's heart failure and COPD. In another example, the personalized social services 54 include: (1) a temporary home care service for 2 weeks; (2) a nutritional intervention service that includes consultation with a dietitian, is salt-free (due to the patient's heart failure) and is a high-protein diet (due to the patient's COPD); psychological care that includes anger management classes; neurological consultations that include a postponement until the patient determines that his insurance covers the service; and a recommendation that the patient be closely monitored to follow the dementia progression; and a recommendation to be put on a waiting list for an independent senior living facility; and a pet care charity that can take care of the patient's dog during hospital visitations.

The outcome processor 64 receives the personalized service plan 90 from the personalized service processor 82 and simulates the personalized service plan 90 to produce the medical service outcomes 94 and the social service (including psycho-social) outcomes 96. The status processor 98 identifies and classifies the medical services outcomes 94 and the social service outcomes 96. The status processor 98 computes the score 104 for each outcome 92. For example, the following services listed are those that have the highest net medical benefit. The medical service outcomes 94 include: (1) a pulmonary rehabilitation service that includes a six minute walking time and a focus on lung capacity, a focus on exercise load, a questionnaire with questions relating to the daily living activities of the patient, and the number of cigarettes smoked per day by the patient; and (2) the physical activity plan that includes a step count plan and an adherence to activity plan. The social service outcomes 96 include: (1) a temporary home care outcome with a focus on increasing patient independence; (2) a nutritional service outcome with a focus on weight, fat mass, and blood test of the patient; (3) neurological consultations with a focus of a prognosis for the progression of the patient's dementia; and (4) a psychological care outcome with a focus on patient satisfaction, an anxiety depression scale, an evaluation of the patient by an expert, and an adherence to the anger management session. The selected outcomes 92 constitute the patient care plan 106.

The status processor 98 produces self-effectiveness evaluation updates 108 of the patient care plan 106. To do so, the scores 104 are collected the medical outcome classifier 112 and the social outcome classifier 114. The medical outcome vector 116 and the social outcome vector 118 are compared to similar vectors contained within the historical patient database 28 using the machine-learning processor 120. In this example, upon a self-evaluation update 108, the scores 104 of the outcomes 92 of the patient care plan 106 are determined to have positive scores 104 (i.e., the patient has improved) except for the anger management outcome (i.e., the patient has not improved). For example, the status vector 80 is updated to state that the patient's heart failure is stable, the COPD is controlled, and the patient no longer has pneumonia, but that the patient's coping skills did not improve. As a result, the patient medical care plan 106 is updated to discharge the patient from all other services 52 and 54 except for the psychological care service (e.g., anger management classes, waiting list independent for senior living).

The patient care plan system 10 is connected to a wide range of sensors and other input data sources. For example, the patient care plan system 10 can be connected to a hospital's information system (e.g., that includes the patient's current and past medical status), other diagnostic data sources (e.g., lab information systems, pharmacy records, monitoring of vital signs, and the like), home medical devices (e.g., weight scales, blood pressure devices, CPAP devices, nebulizers, and the like), home devices (e.g., tablets, television, activity monitors, and the like), questionnaires where patients report their symptoms, attitudes and beliefs, a database describing the patient's current social and clinical services, a database describing the patient's financial constraints and budget for services. The data monitored through the combination of services 52 and 54 is fed back into the method to re-assess the services.

As used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet/Intranet server from which the stored instructions may be retrieved via the Internet/Intranet or a local area network; or so forth. Further, as used herein, a processor includes one or more of a microprocessor, a microcontroller, a graphic processing unit (GPU), an application-specific integrated circuit (ASIC), a field-programmable gate array (FPGA), personal data assistant (PDA), cellular smartphones, mobile watches, computing glass, and similar body worn, implanted or carried mobile gear; a user input device includes one or more of a mouse, a keyboard, a touch screen display, one or more buttons, one or more switches, one or more toggles, and the like; and a display device includes one or more of a LCD display, an LED display, a plasma display, a projection display, a touch screen display, and the like. Stated another way, the patient care plan system 10 can be a non-transitory computer readable medium carrying software to control a processor.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method for creating a patient care plan for a target patient, the method including:
receiving inputs related to one or more social services and one or more medical services that are each associated with target patient data;
selecting one or more social and medical services based on a target assessment;
calculating a net care benefit for each of the selected services;
creating a patient care plan from outcomes including the selected services with a highest net care benefit.

2. The method according to claim 1, further including:
selecting the most cost-effective services for the patient care plan.

3. The method according to claim 1, wherein calculating the net care benefit for each of the selected services includes:
calculating the net care benefit as a function of ability-to-pay, including indicating at least one service that results in a high net care benefit over a target's ability-to-pay.

4. The method according to claim 1, further including:
estimating at least one of medical benefits, resource consumption, and service costs for each of the selected medical and social services.

5. The method according to claim 1, wherein estimation at least one of medical effects, resource consumption, and service costs for each of the selected services further includes:
retrieving historical target data including medical outcomes and costs for a population of targets who underwent each service.

6. The method according to claim 1, further including:
translating the inputs into one or more profiles; and
generating a general service plan from the one or more profiles that corresponds to the selected medical and social services of the population of target patients including one or more selected medical and social services outcomes.

7. The method according to claim 1, further including:
translating the general service plan into one or more statuses;
generating a personalized service plan from one or more status vectors for the target patient including one or more medical and social services outcomes.

8. The method according to claim 1, further including:
continuously monitoring a profile and a status of the target during implementation of the patient care plan; and
updating the patient care plan to achieve a highest net care benefit.

9. The method according to claim 1, further including:
translating each of the selected medical and social services into a service status; and
creating the patient care plan from scores calculated from the service statuses of the medical services and the social services and a reference status of the medical services and the social services of the population of target patients.

10. The method according to claim 1, further including:
classifying each of the scores.

11. The method according to claim 1, wherein:
the medical services are selected from the group including inpatient clinic services, outpatient clinic services, primary care, rehabilitation services, mental medical services, and palliative care; and
the social services are selected from a group including financial assistance services, housing services, personal care services, psychological support services, patient group services, social activities services, dietary support services, employment services, income services, legal services, transportation and mobility services, care management services, home care services, information and assistance services, long-term care services, nutrition and meals services, respite services, senior services, volunteer and intergenerational services, and wellness and well-being services.

12. A patient care plan system, including:
one or more processors programmed to perform the method according to claim 1; and
a display for displaying the inputs and the created patient care plan.

13. The patient care plan system according to claim 12, wherein the at least one processor is further programmed to create a patient care plan with the highest net care benefit from each of the selected services; and wherein
the medical services are selected from the group including inpatient clinic services, specialized outpatient clinic services, rehabilitation services, mental medical services, and palliative care; and
the social services are selected from the group including employment services, income services, legal services, transportation and mobility services, care management services, home care services, information and assistance services, long-term care services, nutrition and meals services, respite services, senior services, volunteer and intergenerational services, and wellness and well-being services.

14. The patient care plan system according to claim 12, wherein the one or more processors are further programmed to:
translate the inputs into one or more profiles;
generate a general service plan from the one or more profiles that corresponds to the selected medical and social services of the population of target patients including one or more outcome medical and social services;
translate the general service plan into one or more statuses;
generate a personalized service plan from the one or more statuses for the target including one or more outcome medical and social services.

15. The patient care plan system according to claim 12, wherein the one or more processors are further programmed to:
continuously monitor a profile and a status of the target patient during implementation of the patient care plan; and
update the patient care plan to achieve the highest net care benefit.

16. The patient care plan system according to claim 12, wherein the one or more processors are further programmed to:
translate each of the selected medical and social services into a service status; and
create the patient care plan from scores calculated from the service statuses of the medical services and the social services and a reference status of the medical services and the social services of the population of target patients.

17. A patient care plan system including means for performing the method according to claim 1.

18. The patient care plan system according to claim 17, wherein the means further creates a patient care plan with the highest net care benefit from each of the selected services; and wherein
the medical services are selected from the group including inpatient clinic services, specialized outpatient clinic services, rehabilitation services, mental medical services, and palliative care; and
the social services are selected from the group including employment services, income services, legal services, transportation and mobility services, care management services, home care services, information and assistance services, long-term care services, nutrition and meals services, respite services, senior services, volunteer and intergenerational services, and wellness and well-being services.

19. The patient care plan system according to claim 17, wherein the means further translates the inputs into one or more profile vectors;
generates a general service plan from the one or more profile vectors that corresponds to the selected medical and social services of the population of targets including one or more medical and social service outcomes;
translate the general service plan into one or more status vectors;
generate a personalized service plan from the one or more status vectors for the target including one or more medical and social service outcomes.

20. The patient care plan system according to claim 17, wherein the means is further programmed to:
translate each of the medical and social services into a service status; and
create the patient care plan from scores calculated from the service statuses of the medical services and the social services and a reference status of the medical services and the social services of the population of target patients.
